(19) United States
(12) Patent Application Publication
(10) Pub. No.: US 2006/0081292 A1
(43) Pub. Date: Apr. 20, 2006

(54) Quickly opening hinged check valve with pre-determined upstream pressure required to open

(75) Inventors: John Sarno, Newhall, CA (US); Tony Madormo, Valencia, CA (US)

Correspondence Address: Donald D. Mon, 750 East Green Street #303, Pasadena, CA, 91101, US

(73) Assignee: MAGIC PLASTICS, INC.

(21) Appl. No.: 10/966,717

(22) Filed: Oct. 15, 2004

(51) Int. Cl. F16K 15/03

(52) U.S. Cl. 137/527

(57) ABSTRACT

A check valve adapted to open only at a predetermined positive pressure, and to open fully and abruptly when said pressure is exerted.

### FIELD OF THE INVENTION

A check valve for water pipes permitting flow in a forward direction, and preventing flow in the reverse direction, but requiring a predetermined upstream pressure to open the valve, and quickly opening fully.

### BACKGROUND OF THE INVENTION

Fluid-conducting installations such as for swimming pools and spas often have two flow branches, each for a respective purpose. In every case, a check valve is required to prevent backflow in the branch, an event which would occur when there is a negative pressure upstream from the valve. The consequences of reverse flow especially include the risk of pollution from a downstream source.

Of course these valves must open for downstream flow, and it is customary for a check valve to open when a positive (downstream directed) pressure is exerted on it. There are, however, some circuits, such as branched circuits for different purposes, which would be frustrated if all of the branches opened at the same low positive differential pressure.

For example, it may be desirable for a slow flow to pass through a sanitizer branch at low pressure and flow while a larger branch for another purpose remains closed. For this purpose, the check valve, while closing at any negative pressure must remain closed at positive pressures lower than some threshold positive pressure. Thus, at some positive pressure below the threshold pressure, one or more check valves can remain closed, while flow is enabled through another branch.

The necessary basic capability for any check valve is for it to have a valve seal which is to open when the flow is from upstream to downstream, but to close when the differential pressure is in the opposite direction. One pervasive problem with such valves is that the closure may dither between open and closed when the system is idling or shut down, and the valve may then be open at times to permit reverse migration of the water.

It is an object of this invention to provide a check valve which is closed when the downstream pressure exceeds that of the upstream pressure, but in addition, which remains closed until the upstream pressure is higher than the downstream pressure by a predetermined and reliable amount.

It is another object of this invention to provide a check valve which, when opened, opens fully and abruptly. Conventional check valves which rely on a spring to hold the closure closed yield gradually when opening, a function of the spring constant. Often such valves will not fully open, and even if they do, the opening is gradual.

It is a further object of this invention to provide this function in a simple valve, most of whose parts can advantageously be cast or molded, and which can be made of materials resistant to erosion or deterioration, for example, from molded organic plastic materials.

It is another object of this invention to provide such a check valve that can be installed as any angular position rather than only straight up.

### BRIEF DESCRIPTION OF THE INVENTION

A check valve according to this invention comprises a body with an axial passage having an upstream inlet port and a downstream outlet port. A fixed peripheral valve seat surrounds the passage, facing in the downstream direction. It forms a port for fluid flow through the valve.

A valve closure in the form of a hinged plate carries a seal which, when the closure is against the body, bears against the seat and closes the port. When it is removed from the port, the port is open to flow. The closure is pivotally mounted to the body so it can swing toward and away from the valve seat.

According to a feature of this invention, the closure is provided with force means, which while the closure bears against the port, the closure can be moved away from the port to open it only upon the exertion of a predetermined upstream force (positive differential pressure). Thus, the closure will remain closed on the valve seat under negative differential pressure and also at suitably low positive pressures. The valve will not open unless and until there is a sufficient predetermined upstream positive pressure.

According to a preferred but optional feature of the invention, the force means comprises a weight carried by the closure spaced from its hinge, said weight establishing a moment on the closure in opposition to the upstream pressure, which will maintain the valve closed until the upstream differential pressure equals or exceeds the predetermined value needed to overcome this moment. How heavy the weight is determines the necessary positive differential pressure to open the valve.

According to yet another preferred but optional feature, the force means comprises a magnetic set, one part of the set being mounted to the body, and the other part of the set being mounted to the closure. The parts are together when the valve is closed, and this holds the closure closed on the valve seat until the force developed by the positive differential pressure equals or exceeds the joinder force of the set. When it does, the parts can separate. The force is determined by the magnetic characteristics of the parts.

According to yet another preferred but optional feature, the force means comprises a pivoted ramped latch engaged to the closure when the valve is closed, which latch is released as the consequence of exertion of a sufficient upstream pressure differential on the closure that overcomes the latch's resistance.

If desired, a bias spring may be provided to ensure that the closure will move toward the valve seat when positive pressure has been discontinued. This spring is intentionally very weak and is not relied on to keep the valve closed or to oppose its opening. The force means does that. It does, however, cause the closure, which is usually a very lightweight part to move toward the valve seat in the absence of positive flow and close the valve.

The above and other features of this invention will be fully understood from the following detailed description and the accompanying drawings, in which:

### BRIEF DESCRIPTION OF THE DRAWINGS

FIG. 1 is a perspective view of a portion of the preferred embodiment of the invention;

FIG. 2 is a side view of FIG. 1 showing this portion in its closed and open conditions;

FIG. 3 is an axial cross-section of the entire check valve including the portion shown in FIGS. 1 and 2;

FIG. 4 is an axial cross-section of another embodiment of the invention, shown in its closed and open conditions; and

FIG. 5 is an axial cross-section of the simplest embodiment of this invention also shown in its closed and open conditions.

### DETAILED DESCRIPTION OF THE INVENTION

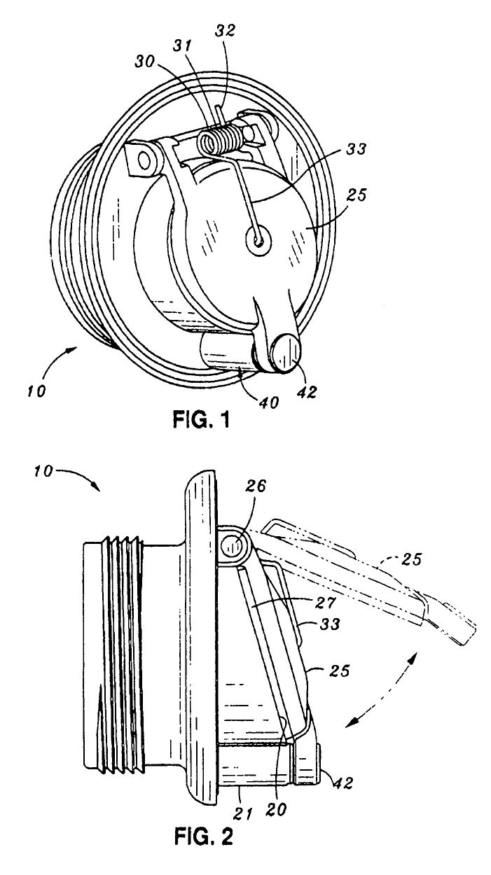

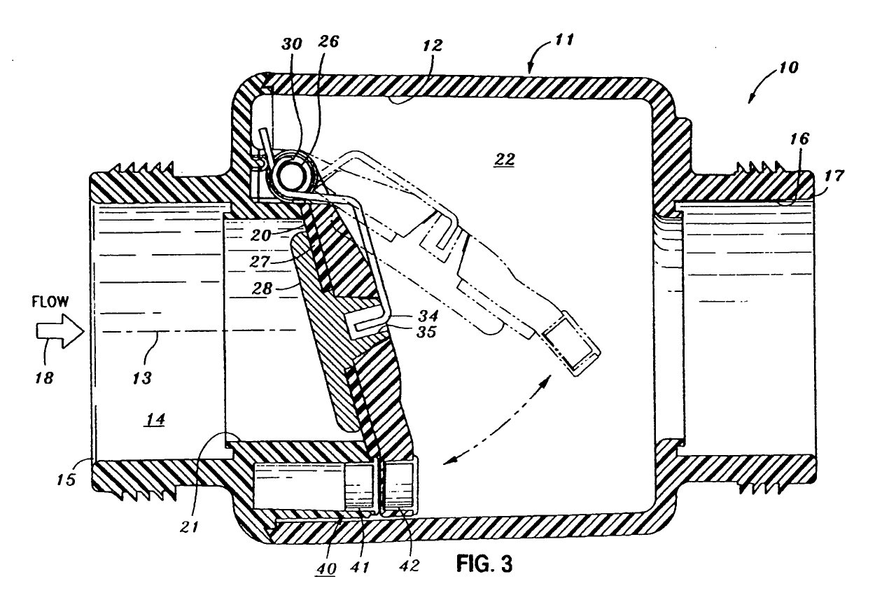

A check valve 10 according to this invention is shown in FIGS. 1-3. It includes a body 11 which forms a circularly shaped passage 12 along an axis of flow 13, from inlet port 14 at this upstream end 15 to outlet port 16 at downstream end 17. Arrow 18 shows the positive direction of forward flow. The opposite direction is of negative backflow.

A peripheral valve seat 20 is formed inside the passage. Preferably it is planar, and disposed at an angle to the central axis. It is conveniently formed on the end of a neck 21 which extends into a valve chamber 22.

A valve closure 25 is a solid structure hinged to body 11 inside chamber 22. A hinge pin 26 mounts the closure body so it can swing from the closed position shown in solid line to the open position shown in dashed line. A flexible valve seal 27 is held flush to the closure body by a retainer 28. The seal can make a fluid-tight closure with the seat when brought against it.

A bias spring 30 has a coil 31 with an anchor end 32 abutting the valve body and a reaction end 33 bearing against the closure. The spring can be stabilized by inserting a bend 34 of the reaction end into a recess 35 in the enclosure. This is a very weak spring, whose strength and function are described below.

Force means 40 is provided at the edge of the closure remote from the pivot. In this embodiment, force means 40 comprises a magnetic set of parts 41, 42, which may both be magnets (of opposite polarity facing one another), or a magnet as one part, and a plate of magnetizable material as the other part. In whatever arrangement, the magnetic set is selected and placed so as to remain in direct contact or in very close proximity of its parts absent a sufficient separation force. This is, in effect, a latch type closure which remains closed until an adequate predetermined separation force is exerted to separate them.

Bias spring 30 is purposely made quite weak. It is not intended to establish an opening pressure, nor to retard the full opening of the valve. Instead its purpose is gently to bias the closure toward the valve seat when there is a zero or negative pressure so that it does not merely stay in an open position. Force means 40 holds the valve closed until the necessary positive pressure is applied to the valve. The bias spring merely lends certainty that the closure will return toward the valve seat in whatever position its hinge is in relative to the horizontal. When used (it is optional) it is just strong enough. Yet it is so weak that the valve can be quickly and fully opened when the force means is released. For example, a usual closure for a two inch valve weights about 1.6 ounces. It requires only a very small force to assure closure. When the valve is installed with the hinge horizontal or reasonably close to horizontal, it can be omitted, but in any event has only a negligibly effect on the rapid opening of the valve. It is of course, assisted by the weight of the closure itself when the hinge is merely horizontal.

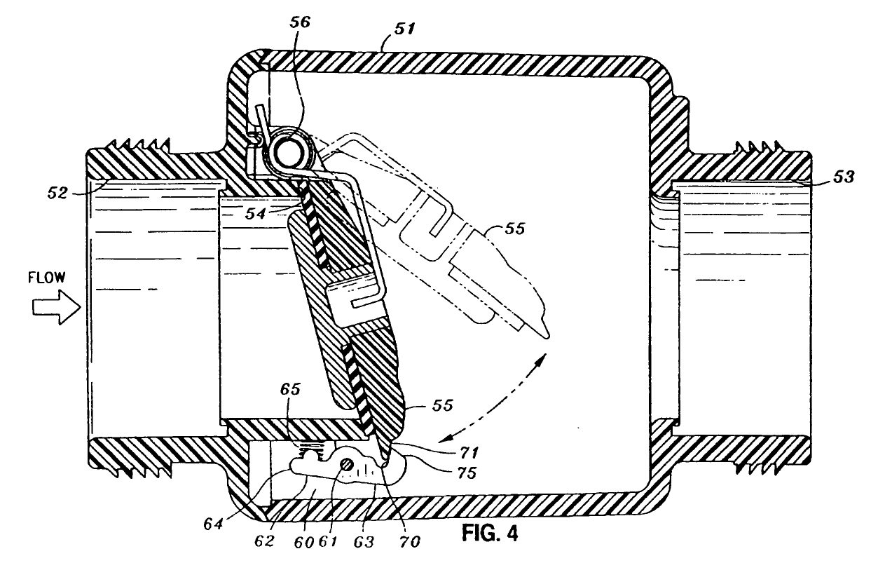

The second embodiment of a check valve 50 according to the invention is shown in FIG. 4. A valve body 51, inlet port 52, outlet port 53, valve seat 54, pivoted closure 54 and bias spring 56 are shown. This structure is generally similar to that of FIGS. 1-3. Bias spring 56 has the same properties and strength as spring 30, for the same reasons.

In this embodiment, force means 60 is provided as a physical latch. A latch pivot pin 61 hingedly mounts a latch plate 62 having a first arm 63 and a second arm 64. A latch spring 65 is interposed between neck 66 and first arm 63, biasing the latch plate counterclockwise in FIG. 4. A ramp surface 70 is formed on the second arm facing toward a latch finger 71 on closure 55. The complementary angles of ramp surface 70 and latch finger 71 when the closure is seated on valve seat 54 will be noticed. This is the latched, closed position. Their engagement holds the closure in place.

Also notice that ramp surface 70 slopes to permit the finger to slide along it when there is a sufficient positive pressure on the closure. This sliding movement is resisted until the bearing force against the ramp surface exerted by the latch finger is sufficient to cause the latch plate to rotate against the force of the latch spring. When this occurs, the closure will abruptly release, and the closure will move to its open position because of the positive fluid force on it.

When the positive force closes, the spring will return the closure to its closed condition. The finger will bear against deflector surface 75 to cause the latch plate to tilt and pass the finger so it can resume the latched position shown in solid line in FIG. 4.

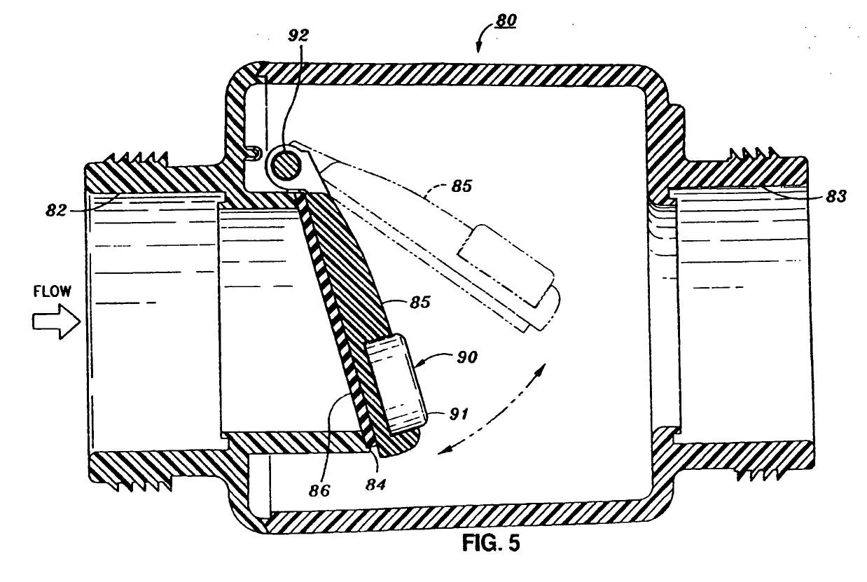

The third and simplest embodiment of a check valve 80 according to this invention is shown in FIG. 5. Again this valve includes a body 81, inlet port 82, outlet port 83 valve seat 84, and a pivoted valve closure 85 with valve seal 86.

In this embodiment, force means 90 comprises a weight 91 spaced from and be placed beneath hinge 92 to exert a moment tending to close the valve. While this arrangement does not provide as abrupt a separation as is enabled by a magnetic pair or a latch, it is reliable, and will resist opening below a predetermined positive pressure. When the pressure goes negative, the weight assists the closure to move to its closed position (a coil spring (not shown) with similar properties to those of spring 30 could be provided, but is not necessary). When the valve is closed, the weight exerts the moment described, and in addition comprises a mass which must be moved by force exerted on the closure. The pivot should, of course be horizontal. The separation force required is a function of the weight of the weight itself which can be selected to provide the desired force.

Should a bias spring such as spring 30 not be desired for some use in any embodiment it may be eliminated, with reliance on the weight of the closure itself to close the valve. In such cases, the hinge axis should be horizontal or nearly horizontal. When a bias spring is used, the alignment of the hinge axis is less important.

This invention is not to be limited by the embodiments shown in the drawings and described in the description, which are given by way of example and not of limitation, but only in accordance with the scope of the appended claims.

We claim:

1. A check valve having a body, an inlet port, an outlet port, and a flow passage between them, so constructed and arranged as to close so as to prevent reverse flow from the outlet port to the inlet port, and to open so as to permit forward flow from the inlet port to the outlet port, but only under positive forward differential pressure at or above a predetermined value, preventing it at pressures lower than said predetermined valve, said check valve comprising:
a valve seat in said passage through which fluid will flow;
a valve closure carrying a valve seal complementary to said valve seat, said closure being pivoted to said body inside said flow passage, adapted to pivot against and close the valve seat in a closed position and to pivot away from said valve seat to open it in an open position; and
force means on said closure for exerting a force on the closure to hold the closure closed, with a predetermined force required to be overcome before the force means will permit the closure to move way from the valve seat.

2. A check valve according to claim 1 in which said force means comprises a magnetic set which develops when engaged, a predetermined retention force that must be overcome for the check valve to open.

3. A check valve according to claim 2 in which said magnetic set comprises a pair of magnets, one on the valve body and the other on the closure.

4. A check valve according to claim 2 in which said magnetic set comprises a magnet and a plate of magnetizable material, one on the closure and the other on the body.

5. A check valve according to claim 1 in which said force means comprises a pivoted latch plate having a first arm and a second arm, said first arm carrying a latch surface engageable by a finger on the closure to resist separation of the closure from the valve seat but so disposed and arranged as to be overcome by a sufficient force exerted by the finger, and a deflector surface also engageable by the finger to displace the first arm and permit the latch to engage when the closure approaches the valve seat, and a latch bias spring interposed between the body and the second arm biasing the latch plate to engage the finger, the predetermined pressure to open the valve being a function of the strength of the latch bias spring, and of the physical relationship between the finger and the latch surface.

6. A check valve according to claim 1 in which said force mean comprises a weight fixed to said closure spaced from and located below the hinge point of the closure, the said predetermined force being a function of the weight of the weight itself.

7. A check valve according to claim 1 in which a bias spring biases the closure toward the valve seat, said bias spring being sufficiently weak as to exert insignificant force tending to increase the amount of force needed to overcome the force means, or for the closure to move freely away from the valve seat.

8. A check valve according to claim 7 in which said force means comprises a magnetic set which develops when engaged, a predetermined retention force that must be overcome for the check valve to open.

9. A check valve according to claim 5 in which a bias spring biases the closure toward the valve seat, said bias spring being sufficiently weak as to exert insignificant force tending to increase the amount of force needed to overcome the force means, or for the closure to move freely away from the valve seat.

10. A check valve according to claim 6 in which a bias spring biases the closure toward the valve seat, said bias spring being sufficiently weak as to exert insignificant force tending to increase the amount of force needed to overcome the force means, or for the closure to move freely away from the valve seat.
